(19) United States
(12) Patent Application Publication
(10) Pub. No.: US 2015/0023847 A1
(43) Pub. Date: Jan. 22, 2015

(54) CRYSTALLIZATION REACTION APPARATUS FOR RECOVERING RESOURCES

(71) Applicant: Seok-woong Kang, Anyang-si (KR)

(72) Inventor: Seok-woong Kang, Anyang-si (KR)

(21) Appl. No.: 14/376,600

(22) PCT Filed: Sep. 24, 2012
(86) PCT No.: PCT/KR2012/007649

§ 371 Date: Aug. 4, 2014

(30) Foreign Application Priority Data
Feb. 3, 2012 (KR) 10-2012-0011356

(51) Int. Cl. B01D 9/00; C02F 1/52

(52) U.S. Cl. CPC B01D 9/0059; C02F 1/52; C02F 2001/5218; C02F 2101/105
USPC 422/254

(57) ABSTRACT

Provided is a crystallization reaction apparatus for recovering resources, which includes at least one agitating impeller provided inside, a seed injection port provided to improve a crystallization effect, and plug-flow formed using at least one isolation layer in order to remove nutrient salts, such as phosphorus (P) and nitrogen (N), exiting in an effluent to cause eutrophication, are removed, the effluent being produced from a dehydration process for sludge discharged through a digestion tank in an sludge waste treatment process for the nutrient salts, such as phosphorus (P) and nitrogen (N), existing in a wastewater treatment water to cause eutrophication, wastewater sludge, food waste and excreta of livestock.

### TECHNICAL FIELD

The present invention relates to a crystallization reaction apparatus, capable of recovering nutrient salts, such as phosphorus (P) and nitrogen (N), exiting in an effluent to cause eutrophication, the effluent being produced from a dehydration process for sludge discharged through a digestion tank in an organic waste treatment process for the nutrient salts, such as phosphorus (P) and nitrogen (N), existing in a wastewater treatment water to cause eutrophication, wastewater sludge, food waste and excreta of livestock, by installing at least one agitating impeller for an effective crystallization reaction, at least one crystalline germ injection port for the improvement in a crystallization effect, and forming plug-flow using at least one isolation layer.

### BACKGROUND ART

Although phosphorus (P) is one of three nutrients for a plant, phosphorus (P) is the rarest nutrient on earth. Current rates suggest that phosphorus (P) buried in the form of mineral will be depleted after next 70 years.

All living cells require phosphors (P). Different from fossil fuel, phosphors (P) has no alternative. The depletion of phosphors (P) causes enormous trouble to agriculture production.

Currently, for the first time in human history, urban population exceeds rural population in number. Foods containing phosphorus (P) have been introduced into a city from a framing area. Since cells are replaced with new one without increasing the number of cells in the case of adults, the adults excrete 98% of an intake of phosphors (P). The phosphorous (P) excreted by persons and phosphors (P) discharged in other ways are flowed into a sewage disposal plant and concentrated in wastewater sludge.

Although a wastewater treatment water, wastewater sludge, food waste and excreta of livestock contain a great amount of nutrient salts, such as phosphorus (P) and nitrogen (N), to eutrophicate and contaminate river or sea, an additional nutrient salt treatment apparatus to efficiently treat the nutrient salts is not provided. Accordingly, a great amount of phosphorus (P) and nitrogen (N) are discharged into the river or the sea so that the river or the sea may be seriously contaminated.

According to an advanced wastewater treatment process of the related art, a portion of sludge sunken into a lower portion of a primary sedimentation tank is transferred to a dehydrator, and a solution provided at an upper portion of the primary sedimentation tank is transferred to a biological reactor to increasingly proliferate microorganisms by dissolving oxygen in the air. In the biological reactor, biochemical oxygen demand (BOD) is removed due to the activity of the microorganisms and phosphorus (P) and nitrogen (N) exerting a great influence on the eutrophication are removed.

In a denitrification process of a biological reaction process, nitrogen (N) is discharged in the phase of gas into the air, and phosphorus (P) is taken into a body of the microorganism in a phostrip process.

Since organic sludge is digested in the state that oxygen supply is cut off in an anaerobic digester provided in a conventional organic waste treatment process, the above microorganisms, which have absorbed phosphorus (P), are decomposed while excreting phosphorus (P) again so that phosphorus (P) mixed and existing in a solution and nitrogen (N) discharged from the sludge feed back into the biological reactor together with a dehydration solution, thereby applying an excessive amount of phosphorus (P) and nitrogen (N) to a main process.

### DISCLOSURE

### Technical Problem

An object of the present invention is to efficiently remove and recover nutrient salts, such as phosphorus (P) and nitrogen (N) included in an effluent to cause eutrophication through a crystallization reaction, in which the effluent is produced when organic sludge including the nutrient salts, such as phosphorus (P) and nitrogen (N), existing in a wastewater treatment water to cause eutrophication, wastewater sludge, food waste and excreta of livestock, is dehydrated after a digestion process.

Another object of the present invention is to improve crystallization reaction efficiency by increasing a reaction time and by providing an agitating opportunity using agitating impellers as an injection port of nutrient salts, such as phosphorus (P) and nitrogen (N), included in treatment water or an effluent is placed at a lower part, and a discharge port to discharge the effluent subject to a reaction is placed at an upper part.

Still another object of the present invention is to form multi-layer plug-flow, to inject a part of crystals, which are discharged to a lower part, into one side of a space between isolation layers under a sedimentation guide isolation member for the use as a crystalline germ, and to inject a crystallization reactant and a pH control agent into the lower portion, thereby increasing a crystallization reaction rate and efficiency.

Still another object of the present invention is to provide a structure of forming a multi-layer (multi-stage) plug-flow with an isolation layer having a higher edge and a lower center to prevent crystals from being accumulated and to form a place, in which the crystals stay, at the center of the isolation layer, thereby improving crystallization efficiency and naturally collecting the crystals down.

Still another object of the present invention is to collect sludge containing crystals using a cyclone separator so that crystals having specific gravity higher than that of the sludge are moved down along an edge wall of the cyclone separator, thereby improving the purity of recovered crystals and increasing the recovery rate of the crystals.

### Technical Solution

In order to accomplish the above objects, according to one aspect of the present invention, there is provided a crystallization reaction apparatus, capable of removing nutrient salts, such as phosphorus (P) and nitrogen (N), exiting in an effluent to cause eutrophication, the effluent being produced from a dehydration process for sludge discharged through a digestion tank in an organic waste treatment process for the nutrient salts, such as phosphorus (P) and nitrogen (N), existing in a wastewater treatment water to cause eutrophication, wastewater sludge, food waste and excreta of livestock, by installing at least one agitating impeller on a rotational shaft provided at the center for an effective crystallization reaction, providing a seed injection port for the improvement in a crystallization effect, and forming plug-flow using at least one isolation layer.

According to another aspect of the present invention, there is provided a crystallization reaction apparatus in which multi-layer plug-flow is formed, each of isolation layers has an edge formed more highly and is lowly inclined toward the center thereof, each isolation is provided at the center thereof with a circular hole, a central portion of the isolation layer adjacent to an agitating impeller horizontally extends by a predetermined distance to allow a predetermined amount of crystals to stay therein to serve as a seed, injection ports are installed at one side of a lower portion to inject a crystallization reactant and pH control agent so that a crystallization reaction is induced, and reaction rate and efficiency can be improved by controlling the pH of the effluent.

According to still another aspect of the present invention, there is provided a crystallization reaction apparatus in which a baffle is installed in order to prevent vortex from being caused by the rotation of an agitating impeller so that the agitating is not smoothly performed in the case of a cylindrical device, a discharge port is provided at a lower portion of the device to discharge crystals, the crystals are injected into one side of a space between isolation layers under a sedimentation guide member placed at an upper portion of a crystallization reactor so that a part of the crystals discharged through the discharge port serves as a seed, and the crystals feed back into a seed injection port installed at the upper portion thereof.

According to still another aspect of the present invention, there is provided a crystallization reaction apparatus in which a sedimentation guide isolation member is fixedly installed at an upper portion of the reaction apparatus, and a treatment liquid discharge port is installed at one side of an upper portion of the sedimentation guide isolation member so that a treatment liquid, which is moved to the upper portion of the sedimentation guide isolation member after crystals, such as phosphorus (P) or nitrogen (N) are separated from the treatment liquid mixed and agitated by agitating impellers and sunken, is discharged through the treatment liquid discharge port.

According to still another aspect of the present invention, there is provided a crystallization reaction apparatus in which a cyclone separator is provided to separate crystals from sludge discharged from a crystallization reactor through a crystal feedback line by centrifugal force, the crystals included in the sludge are moved into a lower portion of the cyclone separator along a wall of the cyclone separator by the centrifugal force and stored in a crystal storage tank installed under the cyclone separator, and sludge generated when the crystals are separated feeds back into a crystal reactor, thereby enhancing the purity of the recovered crystals.

### Advantageous Effects

As described above, according to the present invention, the nutrient salts, such as phosphorus (P) and nitrogen (N) included in an effluent to cause eutrophication can be effectively removed through the crystallization reaction, in which the effluent is produced from a dehydration process after a digestion process for the organic waste, such as the nutrient salts including phosphorus (P) and nitrogen (N) existing in a wastewater treatment water to cause eutrophication, wastewater sludge, food waste, and excreta of livestock.

The present invention has another effect to improve crystallization reaction efficiency by increasing the reaction time and by providing the agitating opportunity using the agitating impellers as the injection port for a digestion sludge effluent containing phosphorus (P) and nitrogen (N) is placed at a lower part, and a discharge port to discharge the effluent subject to a reaction is placed at an upper part.

The present invention has still another effect to form multi-layer plug-flow, to inject a part of the crystals, which are discharged to the lower part, into one side of a space between the isolation layers under the sedimentation guide isolation member for the use as a crystalline germ, and to inject the crystallization reactant and the pH control agent into the lower portion, thereby increasing a crystallization reaction rate and efficiency.

The present invention has still another effect to provide a structure of forming the multi-layer plug-flow with the isolation layer having the higher edge and the lower center to prevent crystals from being accumulated on the isolation layer and to form the place, in which the crystals stay, at the center of the isolation layer, thereby improving crystallization efficiency and naturally collecting the crystals down.

The present invention has still another effect to collect the sludge containing the crystals using the cyclone separator so that the crystals having specific gravity higher than that of the sludge are moved down along the edge wall of the cyclone separator, thereby improving the purity of the recovered crystals and increasing the recovery rate of the crystals.

### DESCRIPTION OF DRAIMPELLERS

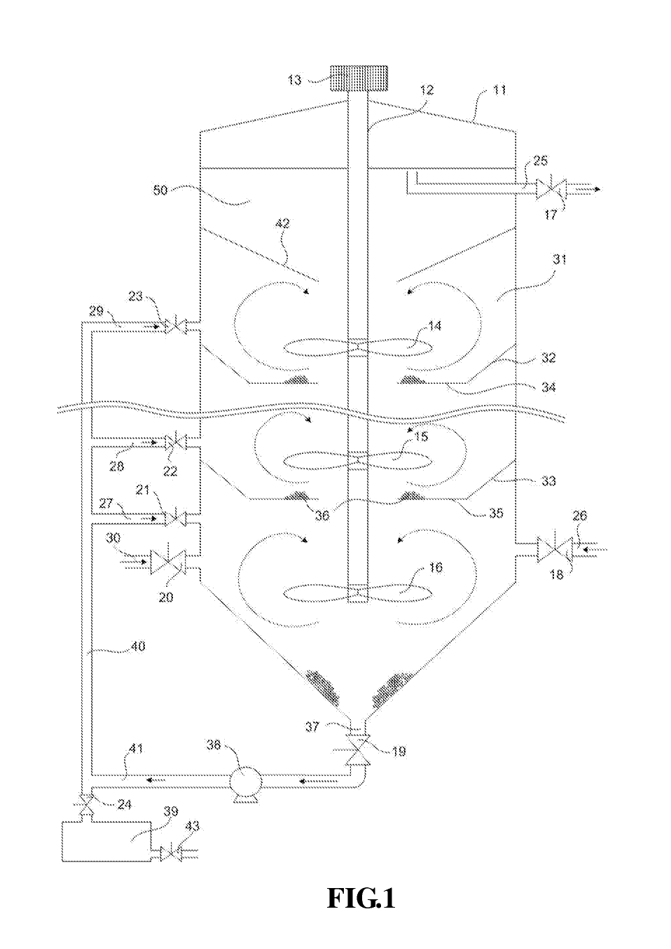

FIG. 1 is a view shoimpeller a crystallization reaction apparatus for recovering resources according to one embodiment of the present invention.

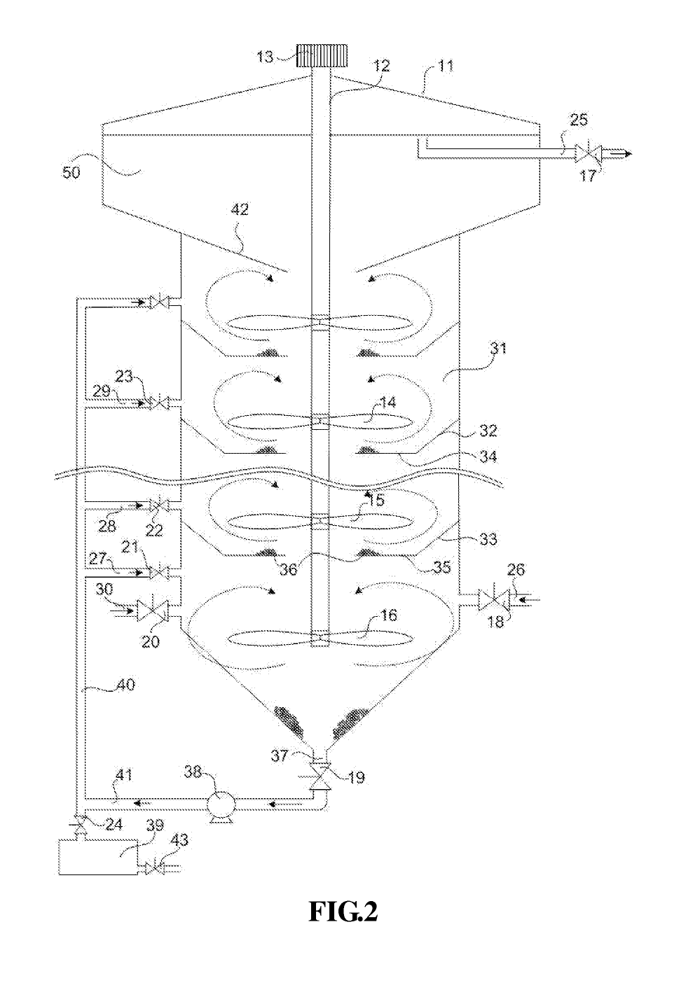

FIG. 2 is a view shoimpeller a crystallization reaction apparatus for recovering resources according to another embodiment of the present invention.

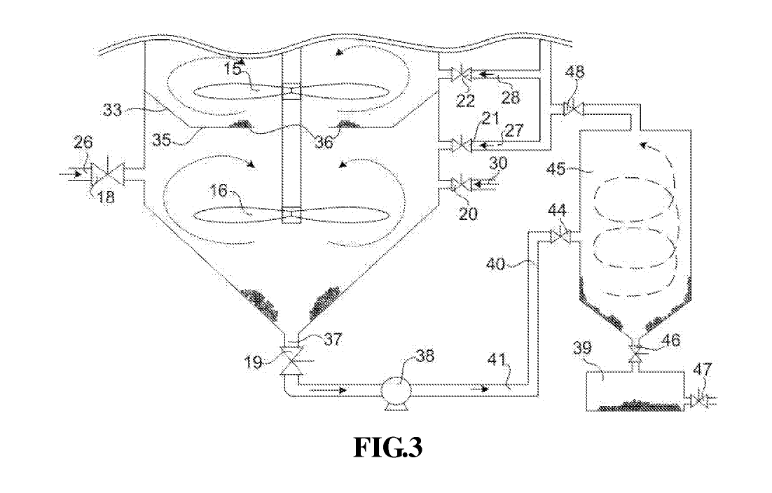

FIG. 3 is a view shoimpeller the crystallization reaction apparatus further including a cyclone separator for crystal separation in the crystallization reactor shown in FIG. 1 or 2.

### BEST MODE

The present invention provides a crystallization reaction apparatus, capable of removing nutrient salts, such as phosphorus (P) and nitrogen (N), exiting in an effluent to cause eutrophication, the effluent being produced from a dehydration process for sludge discharged through a digestion tank in an organic waste treatment process for the nutrient salts, such as phosphorus (P) and nitrogen (N), existing in a wastewater treatment water to cause eutrophication, wastewater sludge, food waste and excreta of livestock, by installing at least one agitating impeller on a rotational shaft provided at the center for an effective crystallization reaction, providing a seed injection port for the improvement in a crystallization effect, and forming plug-flow using at least one isolation layer.

### MODE FOR INVENTION

### Embodiment 1

A first embodiment of the present invention will be described in detail with reference to accompanying draimpellers. FIG. 1 is a view shoimpeller the structure of a crystallization reaction apparatus according to the present invention. FIG. 2 is a view shoimpeller a crystallization reaction apparatus according to another embodiment of the present invention.

FIGS. 1 and 2 make a difference in that a crystallization reactor has a wide upper space, and a sedimentation guide isolation member is further provided, thereby preventing crystals generated after a crystallization reaction from being moved up as much as possible.

Hereinafter, the technical structure according to the present invention will be described in detail with reference to FIG. 1 since the technical structure of FIG. 1 is the same as that shown in FIG. 2 except for the difference.

The present invention suggests a crystallization reactor 11 to remove and recover nutrient salts, such as phosphorus (P) and nitrogen (N), exiting in an effluent to cause eutrophication, in which the effluent is produced from a dehydration process for sludge discharged through a digestion tank in a sludge waste treatment process for the nutrient salts, such as phosphorus (P) and nitrogen (N), existing in a wastewater treatment water to cause eutrophication, wastewater sludge, food waste and excreta of livestock.

Conventionally, since sludge is digested in the state that the supply of oxygen is cut off in an anaerobic digester during a wastewater treatment process, microorganisms, which have taken phosphorus (P), discharge phosphorus (P) again, so that phosphorus (P) is mixed in a solution and the P existing in the solution and nitrogen (N) discharged from sludge in a digestion process may excessively exist in the effluent.

The crystallization reaction apparatus according to the present invention is provided to solve the conventional problem. The crystallization reaction apparatus is provided therein with at least one or two agitating impellers (see reference numerals 14 to 16) in order to make a crystallization reaction by injecting and agitating pH control agents such as potassium, calcium or magnesium for the efficiency reaction.

In order to remove and recover the nutrient salts such as phosphorus (P) and nitrogen (N) included in the treated sewage water or the effluent by crystallizing the nutrient salts, a crystallization reactant including at least one or two selected from among magnesium, potassium, calcium, zinc, calcium carbonate, phosphates, iron salts (FeCl₃), lanthanum, and ammonium are injected into the crystallization reactor so that a magnesium ammonium phosphate (MAP) or a crystal is formed.

In more detail, in order to efficiently recover the nutrient salts such as phosphorus (P) and nitrogen (N) by crystallizing the nutrient salts, Mg2+, NH₄⁺ and PO₄³⁻ serving as crystallization reactants injected into the crystallization reaction apparatus are injected at the injection molar ratio of 1.0-1.4:0.8-1.2:1.0-1.4.

Preferably, the pH control agent includes sodium hydroxide (NaOH) having pH representing strong alkali or a typical strong alkali material to maintain the pH of the effluent, which exists in the crystallization reaction apparatus, in the range of 8 to 12 while accelerating the reaction so that the crystallization reaction can be efficiently performed.

The MAP is used as high quality fertilizer to make varying soil for gardening, seedlings, and golf course rich.

A crystallization reactant injection port to selectively inject at least one or two among magnesium, potassium, calcium, zinc, calcium carbonate, phosphate, iron salt (FeCl₃), lanthanum, and ammonium, which serve as crystallization reactants, may be simultaneously used together with a pH control agent injection port 26 to inject a pH control agent as shown in FIG. 1.

In other words, one crystallization reactant and pH control agent injection port 26 may be installed to periodically inject the crystal reactant and the pH control agent supplied from crystal storage tanks 39, respectively, by a set amount using a quantitative injector. Alternatively, the crystallization reactant injection port and the pH control agent injection port 26 may be individually installed and connected with the crystal storage tanks 39, respectively, to inject the crystallization reactant and the pH control agent by a set amount. The crystallization reactant injection port and the pH control agent injection port 26 may be modified, and at least one crystallization reactant and pH control agent injection port may be provided.

In other words, a crystallization reactant storage tank (not shown) and a pH control agent storage tank (not shown) are individually installed and connected with the crystallization reactant injection port and the pH control agent injection port 26, respectively, through pipes. In this case, valves are installed at one sides of the pipes installed at lower portions of the storage tanks, respectively, and opened or closed to inject the crystallization reactant or the pH control agent to the crystallization reactor.

According to the present invention, at least one isolation layer may be formed in the crystallization reactor 11 to crystallize and treat a great amount of wastewater or effluent, and agitating impellers 14 to 16 are interposed between isolation layers to efficiently agitate the effluent.

Although the isolation layers may be horizontally formed, the isolation layers are preferably designed to be formed at outer portions thereof with isolation layer inclination parts 32 and 33 inclined at a predetermined angle, so that crystals generated through the crystallization reaction may be naturally collected to a lower part as shown in FIG. 1. In addition, the isolation layers are provided at central portions thereof with isolation layer horizontal parts 34 and 35 extending by a predetermined length to provide a place in which parts of the crystals stay in the isolation layer horizontal parts 34 and 35 to serve as crystalline germs 36, thereby improving reaction efficiency.

The isolation layer horizontal parts 34 and 35 according to the present invention are configured to allow the crystals generated through the crystallization reaction to stay therein before the crystals are dropped down to serve as crystalline germs 36, so that the crystallization reaction can be rapidly and efficiently performed.

The isolation layer inclination parts 32 and 33 may have various inclination angles and the isolation layer horizontal parts 34 and 35 may have various lengths if the crystals are dropped down to a floor of the reaction apparatus without being accumulated, and a predetermined amount of crystals stays in the isolation layer horizontal parts to serve as the crystalline germ during the crystallization reaction.

Preferably, an treatment water or treatment liquid injection port 30 is placed at a lower portion of the crystallization reactor 11, and a treatment liquid discharge port 25 for the treatment liquid, which has undergone the crystallization reaction, is installed at one side of an upper portion of the crystallization reactor 11 so that a time in which the effluent of the crystallization reactor 11 stays therein for the reaction is prolonged and the effluent is smoothly agitated by the agitating impellers for the reaction. However, the injection port and the discharge port may be variously designed according to the demands of consumers or the installation places of the crystallization reaction apparatus.

Control values 17 to 24 are installed at one sides of the various injection and discharge ports, respectively, to control an amount of an injected material and an amount of a discharged material.

Initially injected crystalline germs may be injected into the crystallization reactor 11 from an external crystal storage tank through crystalline germ injection ports 27 to 29. A part of the crystals, which are discharged through a crystal discharge port 37 during the operation of the crystallization reactor, feeds back through a crystal feedback pipe 40, so that the crystals may be injected by a set amount.

As shown in FIG. 2, the crystalline germ injection ports 27 to 29 may be fixedly installed at one side of the crystallization reactor between the isolation layers provided under a sedimentation guide isolation member 42 placed at the upper portion of the crystallization reactor through the feedback pipe 40 and an injection amount into the crystalline germ injection ports 27 to 29 may be controlled by valves 21 to 23.

As shown in FIG. 2, the sedimentation guide isolation member 42 is configured in such a manner that the treatment liquid containing the crystals is not directly discharged through the treatment liquid discharge port 25 placed at an upper portion of the crystallization reactor when the agitation process is performed by the upper agitating impeller 14 while the crystallization reaction is made, but the treatment liquid, which is moved up through a hole formed at the center of the sedimentation guide isolation member 42 after the crystals generated through the crystallization reaction and sunken, is discharged through the treatment liquid discharge port 25.

The treatment liquid may be discharged through the treatment liquid discharge port 25 or may be purified once more.

Preferably, the lower portion of the crystallization reactor 11 is designed in the shape of a hopper, so that the crystals generated through the crystallization reaction are discharged through the crystal discharge port 37 provided at the center of the lower portion of the crystallization reactor 11. However, the shape may be modified, and the crystal discharge port 37 may not be located at the center of the discharge port 37.

A crystal transfer pump 38 is installed at one side of a pipe between the crystal discharge port 37 and the crystal storage tank 39 in order to transfer the crystals, which are accumulated at the lower portion of the crystallization reactor, to the crystal storage tank and/or the feedback pipe and the valves 21 to 24 are installed at one sides of pipes to control the transferred crystals.

The agitating impellers 14 to 16 are fixedly installed at a rotational shaft 12 rotated as a driving unit 13 is rotated. Preferably, the agitating impellers 14 to 16 have the structure in which the effluent is moved up from the floor and the isolation layer as shown in FIG. 1 as the agitating impellers are rotated, so that the agitating process can be efficiently performed. However, the agitating impellers 14 to 16 may be modified in various structures.

A metering pump and a discharge pump may be installed at one side of a pipe connected with each injection port or each discharge port to inject and discharge a relevant solution or crystals, respectively, by a set amount.

The internal wall of the crystallization reactor 11 is preferably formed in a cylindrical shape or a rectangular shape. However, at least one baffle is preferably installed perpendicularly to the internal wall of the crystallization reactor since vortexes are caused as the agitating impellers are rotated, so that the agitating operation may not be effectively performed. The internal and external shapes of the crystallization reactor 11 may be modified in various structures.

The driving unit 13 may be designed to operate together with a reduction gear by taking into consideration a rotational speed and rotational force.

The crystallization reactor 11 is provided at the lower portion thereof with the crystal discharge port 37 to discharge the crystals accumulated during the crystallization reaction, and provided at one side of the inner part thereof with a crystal height measuring sensor so that the crystals are discharged through the crystal discharge port 37 when the crystals are sensed as being accumulated by the set amount using the crystal height measuring sensor.

Reference numeral 31 of FIG. 1 represents a structure in which a part of the crystals discharged through the crystal discharge port 37 feeds back to a seed injection port so that a predetermined amount of crystals may be injected through a pipe if necessary. Reference numeral 32 of FIG. 1 represents a pipe to transfer remaining crystals except for crystals used as the crystalline germs into the crystal storage tank.

MAP crystals stored in the crystal storage tank 39 in the final stage are used as high quality fertilizer to make varying soil for gardening, seedlings, and golf course rich.

A control unit of the crystallization reactor, which is not described in detail in the present invention, may operate together with the driving unit, the metering pump, the crystal height measuring sensor, and the valves to automatically perform a control operation.

In the specification of the present invention, since one crystallization reactor 11 is provided, the terminology “crystallization reactor” is used together with the terminology “reactor” formed by shortening the terminology “crystallization reactor”.

The crystallization reaction apparatus may include the crystal storage tank provided at one side of the crystal feedback line to recover a part of crystals.

In addition, the crystallization reaction apparatus may have a sectional area of a sunken region 50 wider than that of a reaction region so that crystals are acceleratedly sunken by reducing a flow rate of a fluid at the sunken region placed above the sedimentation guide isolation member

### Embodiment 2

According to the second embodiment, in order to more efficiently collect crystallized materials after the crystallization reaction has been performed when comparing with that of the first embodiment shown in FIGS. 1 and 2, a cyclone separator is additionally provided as shown in FIG. 3 so that crystals can be collected through centrifugation.

According to the second embodiment shown in FIG. 3, crystals exist together with sludge in the injection into the crystal storage tank 39 according to the first embodiment shown in FIGS. 1 and 2, so that the purity of the crystals may be significantly degraded.

In general, the specific gravity of the crystals generated through the crystallization reaction is about 1.7, and the specific gravity of the sludge is in the range of about 1.05 to about 1.17. Accordingly, when the crystals pass through the cyclone separator, the sludge can be efficiently separated from the crystals.

The liquid (crystals+sludge), which has undergone the crystallization reaction, is injected into the cyclone separator 45 so that the crystals are separated from the sludge using centrifugal force. The separated crystals are transferred into the crystal storage tank connected with a pipe provided a lower portion of the cyclone separator. The sludge generated when the crystals are recovered in the upper portion of the cyclone separator is returned into the crystallization reactor.

Such a technical configuration may enhance the purity of the crystals stored in the crystal storage tank, and increase the recovery rate of the crystals generated after the crystallization reaction has been performed.

Naturally, as shown in FIG. 3, the cost resulting from the additional installation of the cyclone separator may be increased.

In FIG. 3, the additional cyclone separator may be a typical cyclone separator which can be extensively used and is sufficient to separate a material having a different specific gravity from a liquid. The cyclone separator can be selected by taking into consideration a treatment capacity.

As shown in FIG. 3, pipes to be connected with each other as the cyclone separator is additionally provided and valves to move or cut off sludge or sludge having crystals are installed at one sides of pipes.

The crystal feedback pump 38 is installed in one side of a transfer pipe to the cyclone separator at the lower portion of the crystallization reactor 11 so that the sludge including crystals is transferred to the cyclone separator.

In the specification, the crystallization reactor 11 or the reactor refers to a place in which an impeller is installed to perform an agitating operation so that the crystallization is rapidly performed, and the crystallization reaction apparatus has the whole structure shown in FIGS. 1, 2, and 3.

### INDUSTRIAL APPLICABILITY

According to the present invention, in order to remove nutrient salts, such as phosphorus (P) and nitrogen (N), exiting in an effluent to cause eutrophication, the effluent being produced from a dehydration process for sludge discharged through a digestion tank in an sludge waste treatment process for the nutrient salts, such as phosphorus (P) and nitrogen (N), existing in a wastewater treatment water to cause eutrophication, wastewater sludge, food waste and excreta of livestock, the crystallization reaction apparatus having a structure in which at least one agitating impeller is provided inside, a seed injection port is provided to improve a crystallization effect, and plug-flow is formed using at least one isolation layer, thereby improving crystallization efficiency, which represents high industrial applicability.

1. A crystallization reaction apparatus comprising:
a driving unit coupled to a rotational shaft to rotate the agitating impeller; the agitating impeller installed at the rotational shaft coupled to the driving unit to agitate a treatment liquid or an effluent;
a crystallization reactant injected to crystallize phosphorus and nitrogen contained in the treatment liquid or the effluent; and
a treatment liquid or effluent injection port and a treatment liquid discharge port for discharge after a reaction has been performed.

2. The crystallization reaction apparatus of claim 1, further comprising a sedimentation guide isolation member that moves crystals, which are agitated by the agitating impeller and generated through a crystallization reaction, down through a hole formed in a center of the sedimentation guide isolation member after the crystals are sunken, without directly discharging the crystals through the treatment liquid discharge port placed at an upper portion of a reactor.

3. The crystallization reaction apparatus of claim 2, further comprising a crystalline germ injection port which injects a crystalline germ to accelerate the reaction.

4. The crystallization reaction apparatus of claim 3, wherein the crystalline germ injection port includes at least one or two crystalline germ injection ports fixedly installed at one side of each of isolation layers provided under the sedimentation guide isolation member, and
the crystals sunken into a lower portion of a crystallization reactor feeds back into the crystalline germ injection port.

5. The crystallization reaction apparatus of claim 4, wherein a pH control agent is injected into a pH control agent injection port to accelerate a crystallization reaction such that the treatment liquid or the effluent has a pH maintained in a range of 8 to 12.

6. The crystallization reaction apparatus of claim 4, wherein a crystallization reactant is injected into a crystallization reactant injection port to remove and recover nutrient salts including the phosphorus and the nitrogen contained in the treatment liquid or the effluent by crystallizing the nutrient salts, and
the crystallization reactant includes at least one or two selected from among magnesium, potassium, calcium, zinc, calcium carbonate, phosphates, iron salts (FeCl3), lanthanum, and ammonium.

7. The crystallization reaction apparatus of claim 4, wherein a reaction chamber having at least one isolation layer and forming plug-flow is provided to increase a treatment capacity and to accelerate the reaction.

8. The crystallization reaction apparatus of claim 7, wherein the reaction chamber having the at least one isolation layer includes an isolation layer inclination part, which is slowly inclined from an edge toward a center, an isolation layer horizontal part, in which the crystals are placed, and the agitating impeller, and
each isolation layer is provided in a center thereof with a circular hole, and a central portion of the isolation layer adjacent to the agitating impeller horizontally extends by a predetermined distant such that a predetermined amount of crystalline germs stay.

9. The crystallization reaction apparatus of claim 4, wherein the crystallization reactor has an inner part formed in a cylindrical shape or a rectangular shape, and at least one baffle is fixedly installed on an inner wall to prevent vortex from being caused by rotation of the agitating impeller.

10. The crystallization reaction apparatus of claim 4, wherein a treatment water or treatment liquid injection port is placed at one side of the lower portion of the crystallization reactor, and the treatment liquid discharge port for the treatment liquid, which has undergone a crystallization reaction, is installed at one side of an upper portion of the crystallization reactor to increase a reaction time and to accelerate the crystallization reaction through an agitating operation of the agitating impeller.

11. The crystallization reaction apparatus of claim 4, wherein an internal floor of the crystallization reaction apparatus is inclined to allow the crystals generated through the crystallization reaction to be discharged through a crystal discharge port without being accumulated on the internal floor.

12. The crystallization reaction apparatus of claim 4, further comprising a crystal storage tank provided at one side of a crystal feedback line to recover a part of the crystals.

13. The crystallization reaction apparatus of claim 2, wherein a reaction sectional area of a sunken region is wider than a sectional area of a reaction region such that the crystals are acceleratedly sunken by reducing a flow rate of a fluid at the sunken region placed above the sedimentation guide isolation member.

14. The crystallization reaction apparatus of claim 2, further comprising a cyclone separator to separate crystals included in a sludge discharged from the crystallization reactor through a crystal feedback line by centrifugal force, wherein the crystal feedback line is connected with the cyclone separator,
wherein the crystal feedback light is connected with the cyclone separator so that the crystals included in the sludge are moved into a lower portion of the cyclone separator along a wall of the cyclone separator by the centrifugal force and stored in a crystal storage tank installed under the cyclone separator, and sludge generated when the crystals are separated using the cyclone separator feeds back into a crystal reactor.

15. The crystallization reaction apparatus of claim 14, further comprising a crystal feedback pump installed on the crystal feedback line to forcibly transfer the sludge having the crystals into the cyclone separator.
